(19) United States
(12) Patent Application Publication
(10) Pub. No.: US 2015/0185324 A1
(43) Pub. Date: Jul. 2, 2015

(54) LASER RADAR TRACKING SYSTEMS

(71) Applicant: Nikon Corporation, (US)

(72) Inventors: Alexander Cooper, Belmont, CA (US); Michael B. Binnard, Belmont, CA (US)

(73) Assignee: Nikon Corporation, Tokyo (JP)

(21) Appl. No.: 13/870,655

(22) Filed: Apr. 25, 2013

Related U.S. Application Data
(60) Provisional application No. 61/639,700, filed on Apr. 27, 2012.

(51) Int. Cl. G01S 17/66; G01S 7/497; G01S 17/06

(52) U.S. Cl. CPC G01S 17/66; G01S 17/06; G01S 7/4972

(57) ABSTRACT

A laser radar system can include laser tracking functions based on laser flux portions returned from a target and intercepted at annular segmented detectors, or at optical mounting hardware such as spider arms. In some examples, a folding or return mirror is partially transmissive, and directs a portion of the return flux to one or more photodetectors. The return beam portions used for tracking can be detected without significant attenuation or obstruction or a laser radar beam path, so that laser radar and laser tracking can be combined.

### CROSS REFERENCE TO RELATED APPLICATION

This application claims the benefit of U.S. Provisional Application 61/639,700, filed Apr. 27, 2012, which is incorporated herein by reference.

FIELD

The disclosure pertains to laser tracking systems and laser radar.

### BACKGROUND

Laser radar systems can produce detailed surface profiles of distant targets. Such profiles can be used to verify manufacturing processes or qualify manufactured parts as suitable for a particular application. High precision laser radars are generally based on sophisticated optical designs such as those disclosed in U.S. Pat. Nos. 7,139,446 and 7,925,134.

Laser radars generally do not provide a tracking function in which a tracking laser beam is continuously re-oriented so as to follow a target object. Successful laser radar operation requires that laser beam power be used efficiently. Typically, a laser radar scans a focused laser beam over a target surface so as to acquire surface profile data point by point. Such a focused beam is not well suited to laser tracking Laser tracking requires use of a collimated laser beam to follow a moving retroreflector in a wide field of view. Collimating laser radar beams to cover a wide field of view for tracking purposes would introduce significant attenuation in the optical power available for laser radar functions and is incompatible with precise, localized surface measurements for which the laser radar is intended. Accordingly, methods and apparatus that permit combining laser radar and laser tracking functions are needed.

### SUMMARY

Systems, apparatus, and methods are disclosed that permit beam tracking and detection of beam tracking errors and changes without substantially reducing interrogation beam optical power that can be directed to a target for use in, for example, a laser radar. In some examples, laser beam tracking apparatus comprise an optical system configured to direct an interrogation optical beam to a target and receive a returned portion of the interrogation optical beam. The returned portion can be detected for providing a beam position estimate with an annular photodetector, reflective surface portions on spider arms that are situated to direct returned portions to one or more detectors, detectors situated on one or more of the spider arms, or detectors situated to receive returned portions through or from a return reflector.

Optical apparatus comprise an optical system configured to produce an interrogation optical beam, the optical system including a spider mount having a plurality of spider arms, and configured to secure an optical fiber along an axis and direct an optical flux from the fiber to a focusing element to produce an interrogation optical beam. A beam tracker is configured to produce a beam position estimate based on a portion of the optical flux returned from a target and incident to the spider arms. In some embodiments, photodetectors are situated at one or more of the spider arms, wherein the beam tracker is configured to produce the beam position estimate based on electrical signals associated with the portion of the returned optical flux incident to the photodetectors. In other examples, reflective surfaces are situated at one or more of the spider arms to direct portions of the returned optical flux to one or more detectors, wherein the beam tracker is configured to produce the beam position estimate based on electrical signals associated with the portion of the returned optical flux incident to the photodetectors.

In still further examples, optical apparatus comprise an optical system configured to produce an interrogation optical beam. The optical system includes a beam focusing element and a partially transmitting return reflector situated on an axis. The return reflector is situated so that separation of the beam focusing element and the return reflector is variable so as to focus the interrogation optical beam at a target. A beam position detection system is configured to receive at least a portion of a return optical flux from a target either transmitted or reflected by the return reflector.

In some examples, measurement apparatus comprise a laser radar system configured to receive an interrogation optical beam from a target at an objective lens situated along an axis, wherein the objective lens is configured to direct the received interrogation optical beam to a detection system so as to produce an estimate of a target distance. A tracking system is configured to direct a tracking optical beam to an object, wherein the tracking system comprising a multi-element detector configured to receive at least a portion of the tracking optical beam from the objective lens. In some examples, the tracking system includes a processor configured to estimate an angular position of the object based on a distribution of the received portion of the tracking optical beam at the elements of the multi-element detector. In typical examples, the multi-element detector includes annular elements situated so as to define an aperture, wherein the aperture is configured to transmit the received interrogation beam to a laser radar detection system. In other alternatives, the multi-element detector is situated on the axis or proximate the objective lens.

In further examples, the laser radar includes a focus adjustment system that includes a corner cube and a return reflector, wherein the return reflector is configured to transmit at least a portion of the tracking optical beam. The multi-element detector is situated to receive the portion of the tracking beam transmitted by the return reflector. In some examples, the multi-element detector is a quadrant detector or a detector array. In some representative examples, the return reflector includes a patterned partially transmissive coating configured to transmit portions of the tracking beam at at least one pattern area to the multi-element detector. In some alternatives, at least one reflective surface is configured to direct the portion of the tracking beam transmitted by the return reflector to the multi-element detector. In still additional examples, the multi-element detector is situated at the return reflector and is situated as to receive at least a portion of the tracking beam as directed toward the return reflector or reflected by the return reflector.

In some examples, the objective lens is configured to direct the interrogation optical beam and the tracking optical beam to the target. According to some embodiments, a focus controller is configured to selectively adjust a beam focus so as to produce the interrogation optical beam and the tracking optical beam. In other embodiments, the focus controller is configured to produce a focused interrogation optical beam at the target, and produce a collimated tracking optical beam. In typical embodiments, a laser diode is configured to produce the interrogation optical beam and the tracking optical beam. According to representative examples, a beam pointing system is configured to select a beam pointing direction based on the received portion of the tracking optical beam and the estimated angular position. In some examples, the beam pointing system is configured to direct the tracking beam to the estimated angular position.

In some representative embodiments, an optical fiber is situated so as to direct the interrogation optical beam to the objective lens and a spider mount having at least two spider legs is configured to retain the optical fiber. At least two elements of the multi-element detector are situated to receive the portion of the tracking optical beam from respective spider legs, and in some examples, the at least two elements of the multi-element detector are secured to the respective spider legs. In other embodiments, the spider legs include reflective surfaces situated to direct the tracking optical beam portion to the at least two detector elements. According to some examples, at least one of the reflective surfaces is configured to direct the tracking beam portion away from the axis or to focus the tracking beam portion at selected element of the multi-element detector.

Methods comprise receiving an optical beam from target along a laser radar axis and directing a portion of the received optical beam to a multi-element detector. Based on portions of the received optical beam detected by the elements of the multi-element detector, an angular location of the target is estimated. In some examples, the laser radar axis is adjusted based on the estimated angular location. According to some examples, the elements of the multi-element detector are situated to receive perimeter portions of the received optical beam. In other embodiments, the received optical beam is directed to an optical fiber associated with the laser radar, and the elements of the multi-element detector are situated to receive portions of the received optical beam obstructed by a fiber mount. According to typical examples, the fiber mount is a spider mount having a plurality of spider arms, and the elements of the multi-element detector are situated to receive portions of the received optical beam obstructed by the spider arms. In representative examples, the spider arms are configured to reflect portions of the received optical beam to the elements of the multi-element detector.

According to representative embodiments, the laser radar includes a focus adjustment system, and the elements of the multi-element detector are situated to receive portions of the received optical beam from the focus adjustment system. The focus adjustment system includes a corner cube configured to be translatable along the laser radar axis and a return reflector situated along the axis, and further wherein the return reflector couples the received beam to the multi-element detector by transmission or reflection. In further examples, a target distance is estimated by directing an interrogation optical beam to the target along the laser radar axis. A tracking optical beam is directed to the target such that the received optical beam corresponds to a portion of the tracking optical beam, wherein the estimated angular location of the target is determined with respect to the laser radar axis. In some examples, the interrogation optical beam is focused at the target, and the tracking optical beam is a collimated optical beam. In still additional examples, an orientation of the laser radar axis is repetitively adjusted based on the estimated angular location. In some representative examples, the angular location of the target is estimated based on error signals associated with a received power difference between at least two elements of the multi-element detector.

Laser radar and tracker systems include an optical system configured to direct an optical beam along a laser radar axis to a target and receive a return beam so as to determine a target distance. A means for intercepting a portion of the return optical beam is configured to direct the beam portion to a detection system, and a processor is configured to determine a target angular location based on the intercepted portion. In some examples, the optical system includes focusing optics that direct the optical beam to the target, and the means for intercepting is a segmented annular photodetector having a central transmissive portion that is situated on the laser radar axis. In other embodiments, the optical system includes at least one partially transmissive mirror, and the means for intercepting includes at least two photodetectors situated to receive a portion of the optical beam transmitted by the partially transmissive mirror. In still further examples, the optical system includes a spider mount configured to retain a fiber end that delivers an optical flux to form the optical beam. The spider mount includes a plurality of spider arms extending radially outwardly from a fiber retainer; and the means for intercepting are the spider arms.

The foregoing and other objects, features, and advantages of the disclosure will become more apparent from the following detailed description, which proceeds with reference to the accompanying figures.

### BRIEF DESCRIPTION OF THE DRAWINGS

FIG. 1 is a schematic diagram of a representative laser radar or laser tracking system that includes an annular quadrant detector.

FIGS. 2A-2B illustrate a segmented annular detector.

FIG. 3 illustrates an annular segmented detector having eight detector segments.

FIG. 4 illustrates concentric segmented annular detectors.

FIG. 5 illustrates a segmented detector defining a square central aperture.

FIGS. 6, 7A-7B, and 8A-8B illustrate additional segmented annular detectors situated about respective common apertures.

FIG. 9 illustrates a series of discrete photodetectors secured to a retaining ring.

FIG. 10 illustrates a spider mount having spider arms to which photodetectors are secured.

FIG. 11 illustrates a spider mount having a segmented annular detector.

FIG. 12 illustrates a representative laser tracking system that includes a reflective spider such as those illustrated in FIGS. 13-16.

FIGS. 13-16 illustrate spider mounts having reflective surfaces defined on one or more spider arms.

FIG. 17 illustrates a representative laser tracking system that includes a partially transmissive mirror situated to couple an optical beam to a quadrant detector for estimation of a beam pointing direction or direction error.

FIGS. 18A-18D and 19 illustrate multi-element detection based on optical fluxes transmitted or reflected by a return reflector.

FIG. 20 illustrates obtaining tracker signals at a corner cube.

FIG. 21 illustrates a spider mount configured to retain an optical fiber bundle.

FIG. 22 is a simplified block diagram of a combined laser radar/laser tracker.

FIG. 23 is a block diagram of a representative method of tracking a tooling ball that is secured to a substrate or target.

FIG. 24 is a block diagram of a representative manufacturing system that includes a laser radar or other profile measurement system to manufacture components, and assess whether manufactured parts are defective or acceptable.

FIG. 25 is a block diagram illustrating a representative manufacturing method that includes profile measurement to determine whether manufactured structures or components are acceptable, and if one or more such manufactured structures can be repaired.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

For convenience in the following description, the terms “light” and “optical radiation” refer to propagating electromagnetic radiation that is directed to one or more targets to be profiled, detected, or otherwise investigated. Such radiation can be referred to as propagating in one or more “beams” that typically are based on optical radiation produced by a laser. In addition, such beams can have a spatial extent associated with one or more laser transverse modes, and can be substantially collimated or focused.

For convenience, beams are described as propagating along one or more axes. Such axes generally are based on one or more line segments so that an axis can include a number of non-collinear segments as the axis is bent or folded or otherwise responsive to mirrors, prisms, lenses, and other optical elements. The term “lens” is used herein to refer to a single refractive optical element (a singlet) or a compound lens that includes one or more singlets, doublets, or other elements. In some examples, beams are shaped or directed by refractive optical elements, but in other examples, reflective optical elements such as mirrors are used, or combinations of refractive and reflective elements are used. Such optical systems can be referred to as dioptric, catoptric, and catadioptric, respectively. Other types of refractive, reflective, diffractive, holographic and other optical elements can be used as may be convenient.

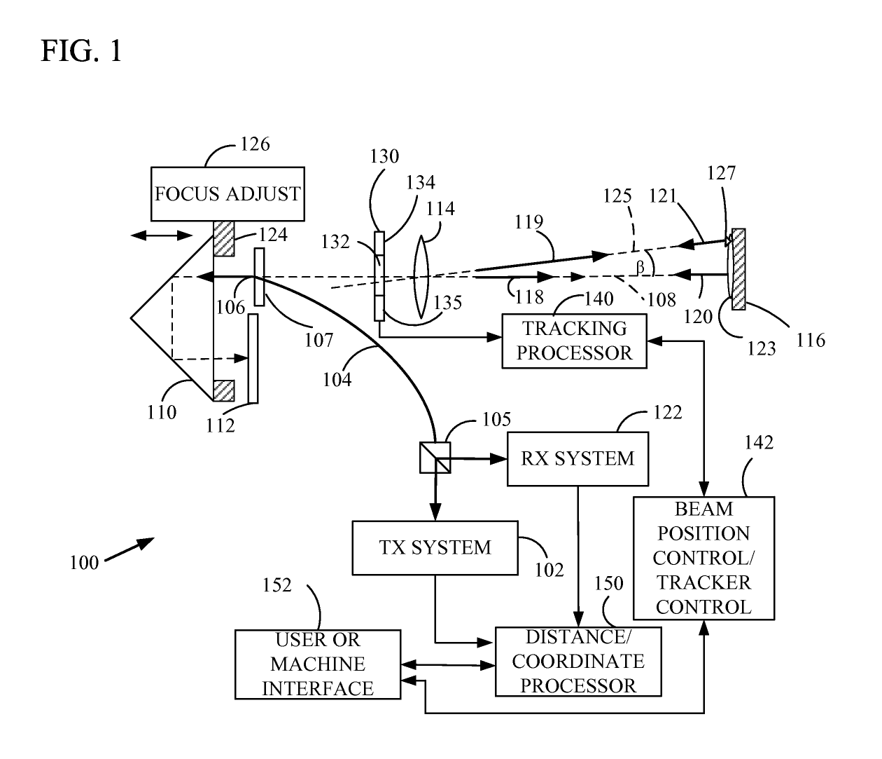

With reference to FIG. 1, a laser radar system 100 includes a transmitter system 102 that is configured to couple an optical beam from one or more laser diodes or other light sources to an optical fiber 104 through a beam splitter 105. The optical beam exits the optical fiber 104 at a fiber end 106, typically a cleaved or plane polished fiber end, and is directed along an axis 108 to a corner cube 110 and a return mirror 112. The fiber end 106 is retained by a spider assembly 107. The return mirror is 112 is situated along the axis 108 as folded by the corner cube 110 to return the beam through the corner cube 110 to an objective lens 114 that produces a focused interrogation or tracking optical beam 118 that is directed to a target 116. Focus is typically adjusted by translating the corner cube 110 along the axis 108. At least some portion 120 of the interrogation beam 118 is scattered, reflected, or otherwise returned to the objective lens 114 and coupled (via the corner cube 110 and the return mirror 112 to the fiber end 106 and to a receiver system 122. The corner cube 110 is secured to a focus mechanism 124 that is configured to translate the corner cube 110 along the axis 108 to focus the interrogation beam 118 at particular distance. The returned portion 120 of the interrogation beam can be used in laser radar processing to provide target coordinates.

The interrogation beam 118 can also be collimated or made divergent to form a tracking beam so as to be incident to a target area 123 (or target angular field), and beam portions such as beam portion 121 returned. In some examples, the target area is provided with a highly reflective target 127 such as a corner cube or other retroreflector to aid in detection of the return beam portion 121. The tracking beam can be formed using the focus mechanism, or otherwise defocussing the interrogation beam so as to cover the target area 123. Tracking of a target location (such as location of a corner cube) can be accomplished based on the beam portion 121.

As shown in FIG. 1, an annular photodetector 130 is situated on the axis 108 and includes a central aperture 132 having a relatively high transmittance (for example, greater than 75%,80%, 85%, 90%, 95%, or more) to a returned portion 121 of a tracking optical beam. One or more photodetectors 134, 135 are situated about the central aperture 132 and are coupled to a tracking processor 140. Electrical signals from the photodetectors 134, 135 are processed to determine interrogation beam location with respect to the axis 108. In some examples, two, three, four or more such photodetectors can be provided. The detector 130 can be situated at various locations between the lens 114 and the reflector 112, and the position of FIG. 1 is just an example. Generally, the detector 130 is situated so that 75%, 80%, 85%, 90%, 95%, or more of a return beam associated with the interrogation optical beam or the tracking optical beam is transmitted by the control aperture 132 for use in laser radar or other measurements and the remainder of the return beam (either an interrogation or a tracking beam) is available for the associated photodetectors.

The annular photodetector 130 permits beam misalignments to be assessed and corrected, if desired, as well as permitting detection of returned portions of tracking beams and establishing a return direction. As shown in FIG. 1, the interrogation beam 118 propagates along the axis 108. However, in some cases, such as, for example, in the presence of misalignments of one or more optical components with respect to the axis 108, the interrogation beam propagates at an angle with respect to the axis 108, and is directed to the target 116 along a tilted axis 125. For example, an interrogation beam 119 propagates at a tilt angle β with respect to the axis 108, and is incident to the target 116 offset from the axis 108. A returned portion of the flux 119 is received by the objective lens 114 and formed into a converging return beam that propagates at an angle with respect to the axis 108. The converging return beam is directed to the fiber end 106 for coupling to the receiver system 122. A central portion of the converging return beam is incident to the annular detector 130 offset from the axis 108 a distance δ based on the tilt angle β and the separation of the annular detector 130 and the objective lens 114 along the axis 108. Perimeter portions of the converging returned beam are detected by one or more of the detectors 134, 135 and differences in the detected portions are used by the tracking processor 140 to estimate the tilt angle β or otherwise determine or estimate interrogation beam pointing direction. A beam position controller 142 can be coupled to adjust beam position by adjusting one or more of the system optical components based on a tilt or displacement with respect to the axis 108, and adjust beam position by controlling a mounting system that can adjust azimuth and elevation angles of the beam shaping optical system.

Tracking can be similarly provided based on a return beam portion such as that from the corner cube 110. If this beam portion is not aligned with the axis 108, detector signals associated with one or more of the detectors 134, 135 or other detectors will be unequal and the difference in signal level used to estimate corner cube location. In addition, based on the estimated location, the optical system can be adjusted so that the axis 108 and the corner cube 110 are aligned, if desired. Thus, based on the detected signal difference, the location of the corner cube 110 can be tracked as the corner cube 110 is moved.

The laser radar system 100 also includes a processing system 150 that is coupled to the transmitter system 102 and the receiver system 122. Based on transmitted and received optical signals, the processing system 150 can estimate distances and other coordinates associated with the target, or selected portions of the target 116. Measurement results are provided directly for user inspection or relayed to analysis systems at an interface 152. The laser radar system 100 can be configured as a frequency modulated continuous wave system, as an amplitude or phase modulated system, or a combination of such systems.

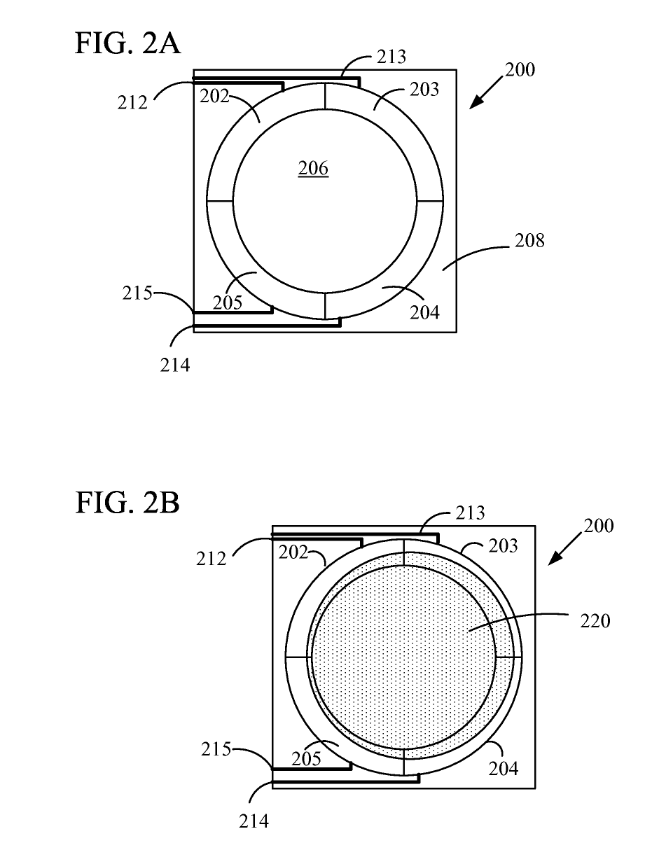

With reference to FIG. 2A, an annular, multi-segmented photodetector 200 includes annular photodetectors 202-205 situated about an aperture 206. As used herein, annular region need not extend completely about an axis, and correspond to annular segments. The photodetectors 202-205 are typically formed on or secured to a substrate 208 in which the aperture 206 can be defined as a substrate void, or a portion of the substrate 208 that is transmissive to an interrogation optical beam. A diameter or other dimension of the aperture 206 can be selected based on an anticipated beam diameter so that a beam is only slightly attenuated, and substantially all beam power is transmitted through the aperture 206. Conductive strips 212-215 are provided on a surface of the substrate 208 for electrical connection to the photodetectors 202-205, and a common connection can be provided on an opposite surface of the substrate 206, but connections of other types and at other locations can be made. In addition, multiple discrete photodetectors can serve as a multi-element detector.

For purposes of illustration, FIG. 2B shows the annular multi-segmented photodetector 200 of FIG. 2A, but with a representative return beam footprint 220 representing a region of incidence of a return beam. The beam footprint 220 corresponds to a beam edge that can be defined as a beam position at which a beam intensity has fallen to a predetermined fraction of a peak or reference intensity such as 1/e, ½, ⅕, 1/10 or other fractional intensity. In the illustrated arrangement, photodetectors 203, 204 would produce larger corresponding electrical signals than photodetectors 202, 205, and beam displacement toward these detectors is indicated.

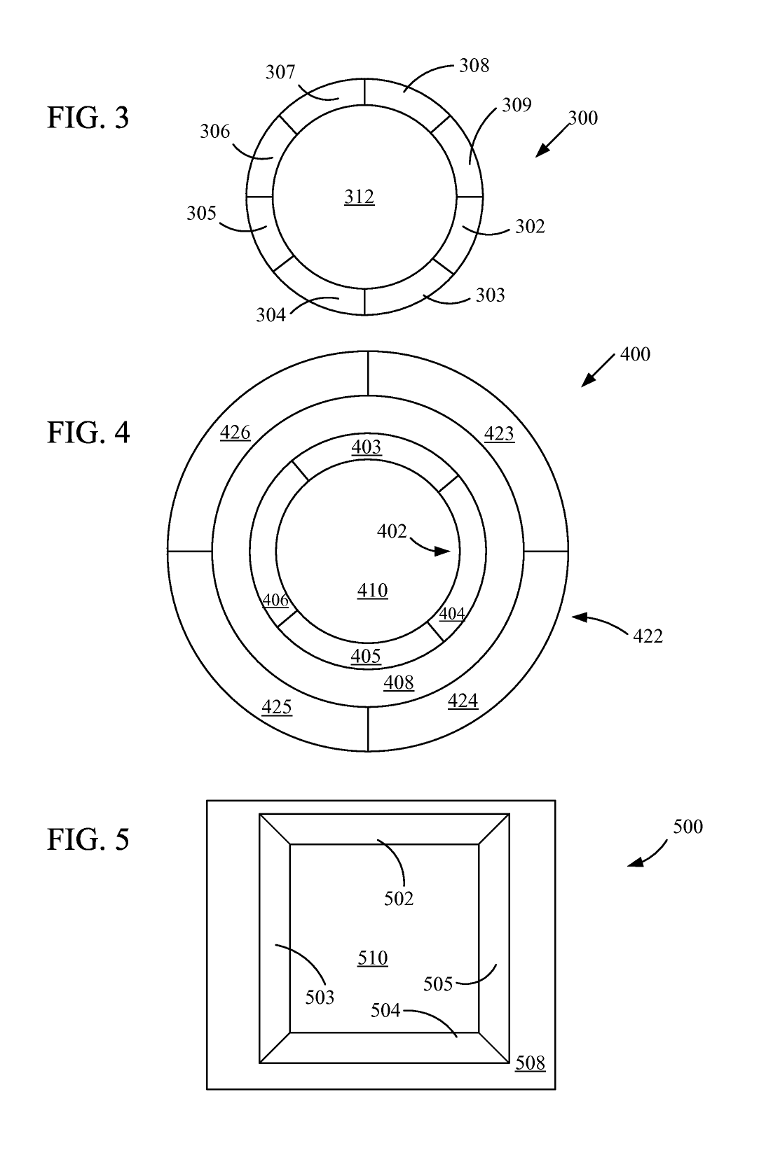

FIG. 3 illustrates a portion of an alternative annular detector 300 that includes eight equal detector segments 302-309 situated about a central circular aperture 312.

FIG. 4 illustrates concentric annular detectors 402, 422, each having respective detector segments 403-406, 423-426 segments situated about an aperture 410. As shown in FIG. 4, the detector segments 403-406 of the annular detector 402 are rotated by 45 degrees with respect to the detector segments 423-426 of the annular detector 422 about an axis through a center of the aperture. The annular detectors 402, 404 define an annular aperture 408. Electrical connections and substrates are not shown for ease of illustration.

FIG. 5 illustrates a rectangular annular detector 500 having detector segments 502-505 on a substrate 508 situated about a central aperture 510.

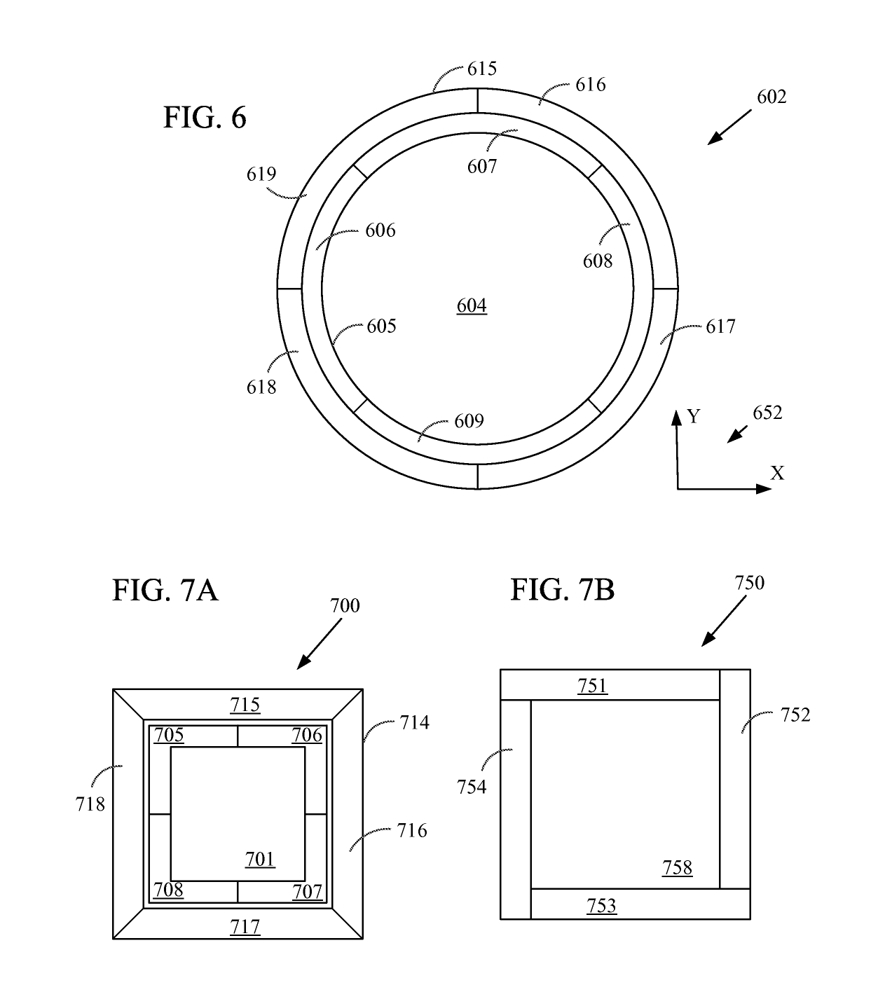

FIG. 6 illustrates a detector 602 that includes segment annular detectors 605, 615 that include respective segments 606-609, 616-620 situated about an aperture 604. With respect to an XY-coordinate system 652, X and Y error signals EX and EY for tracking can be determined as EX=(E₆₁₆+E₆₁₇)−(E₆₁₈+E₆₁₉) and EY=(E₆₁₆+E₆₁₉)−(E_{617+E}₆₁₈), wherein E₆₁₆, E₆₁₇, E₆₁₈, E₆₁₉ are associated with optical power received at detectors 616, 617, 618, 619, respectively. Additional error signals can be based on the detector 605. Error signals such as EX, EY can be associated with beam position in the aperture 604, and based on a suitable scale factor, such signals can be associated with tracking angles.

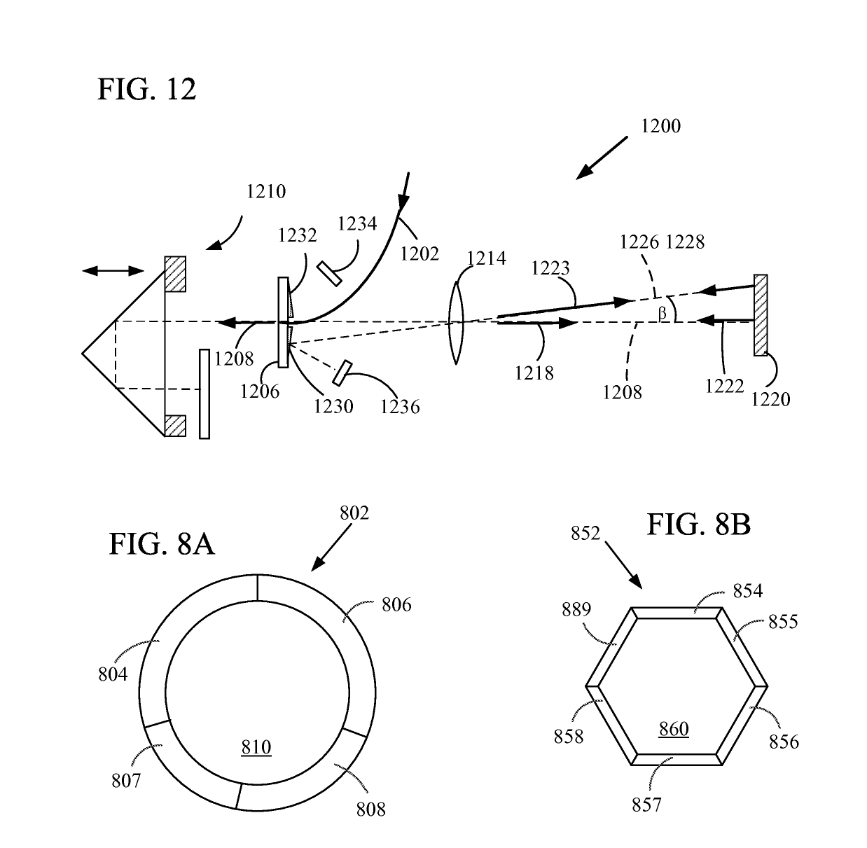

FIG. 7A illustrates a detector 702 that comprises rectangular segmented annular detectors 704, 714 that include respective detector segments 705-708, 715-71. The detector 700 includes a rectangular central aperture 701, but circular, elliptical, polygonal, or other aperture shapes can be used. FIG. 7B illustrates a segmented detector 750 that defines detector segments 751-754 about a square aperture 758. In another example shown in FIG. 8A, a segment annular detector 802 includes unequal segments 804-807 situated about a circular aperture 810. In yet another example shown in FIG. 8B, a hexagonal annular detector 852 includes segments 854-859 situated about a hexagonal aperture 860. In some examples, detector segments can be of the same or similar sizes or shapes, but varying shapes and varying lengths, widths, radii, or other dimensions can be used. Such detectors can be arranged evenly or unevenly in circles, squares, rectangles, polygons, ellipses, or other curves, and be situated about apertures of the same or different shapes.

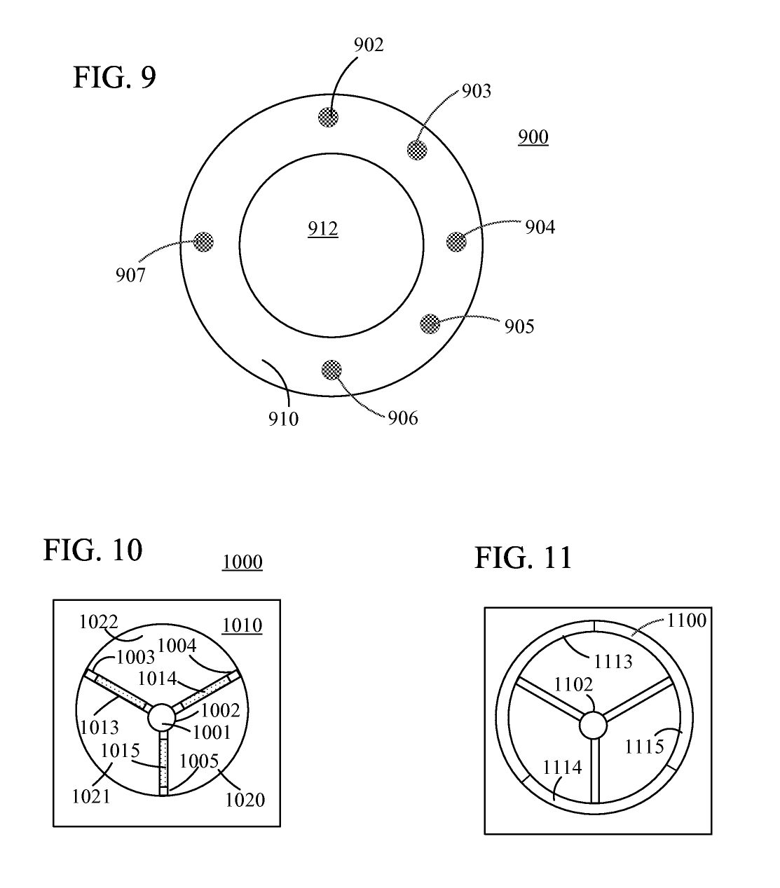

With reference to FIG. 9, a detector assembly 900 includes a plurality of detectors such as detectors 902-907 secured to a mounting ring 910 having a central aperture 912. As shown in FIG. 9, six discrete detectors are provided, but more or fewer can be used and can be evenly or unevenly spaced. As with segmented detectors, three or more are preferred for detection of beam offsets in two dimensions, and detectors and segments can have photosensitive regions of various shapes such as circular, polygonal, elliptical, and other regular or irregular shapes. The photosensitive areas can be uniformly or non-uniformly spaced, and can be situated about apertures that are centered or decentered with respect to the detectors. The more regular geometries illustrated are provided only as convenient examples.

Referring to FIG. 10, a spider assembly 1000 includes a plurality of spider arms 1003-1005 that extend from a spider base 1010. A retaining ring 1002 is supported by the spider arms 1003-1005 and defines a fiber aperture 1001 that is suitable for securing an optical fiber in a laser tracking optical system such as illustrated in FIG. 1. The spider arms 1003-1005 and the spider base 1010 further define apertures 1020-1022 that transmit optical radiation, and an optical beam directed through the apertures 1020-1022 tends to be blocked only by the spider arms 1003 and the retaining ring 1002. The spider arms 1003-1005 can be provided with respective photodetectors 1013-1015, so that portions of the optical radiation blocked by the spider arms 1003-1005 can be used in beam tracking The photodetectors 1013-1015 are preferably configured so as to occupy all or a substantial portion of the spider arm surface area that blocks an optical beam. In a typical laser tracker configuration, an optical fiber is secured in the aperture 1001 so as to provide an optical flux to beam shaping optics. To detect portions of a return beam for tracking, the photodetectors 1013-1015 are arranged so as to face in an opposing direction. In other examples, such as shown in FIG. 11, an annular segmented photodetector 1100 that includes photodetector segments 1113-1115 is situated about spider arms and a fiber retaining ring 1102.

In other examples, spider arms can be configured to direct portions of a returned optical flux to corresponding detectors, or more generally, to one or more detectors. With reference to FIG. 12, a laser radar 1200 includes a fiber 1202 that is secured with respect to an optical axis 1208 by a spider mount 1206 to direct an interrogation optical flux 1208 to a corner cube based focus adjustment system 1210. A lens 1214 is situated to direct an interrogation beam 1218 to a target 1220 and produce a reflected, refracted, scattered, or other return flux 1222 that is directed back to the lens 1214. In some cases, an interrogation beam 1223 is directed along an axis 1226 that is tilted with respect to the axis 1208, and an optical flux 1228 is returned along the axis 1226.

A substantial tilt of the axis 1226 is shown for convenience in FIG. 12. Portions of a return flux are intercepted by first and second spider arm reflectors 1230, 1232 and are directed to respective detectors 1234, 1236. The detectors 1234, 1236 are coupled to signal amplifiers, filters, and other processing as may be preferred, and a tracking processor (not shown) evaluates the detector signals to estimate a pointing direction. Based on the estimated pointing direction, pointing direction can be corrected or compensated for in determination of target location. Alternatively, pointing direction can be changed so as to track a target location. Two detectors and two reflective segments with different tilts or curvatures are shown for ease of illustration, but in other examples, a common tilt or curvature can be used, and one or more discrete detectors or a quadrant detector (including an annular quadrant detector) can be used.

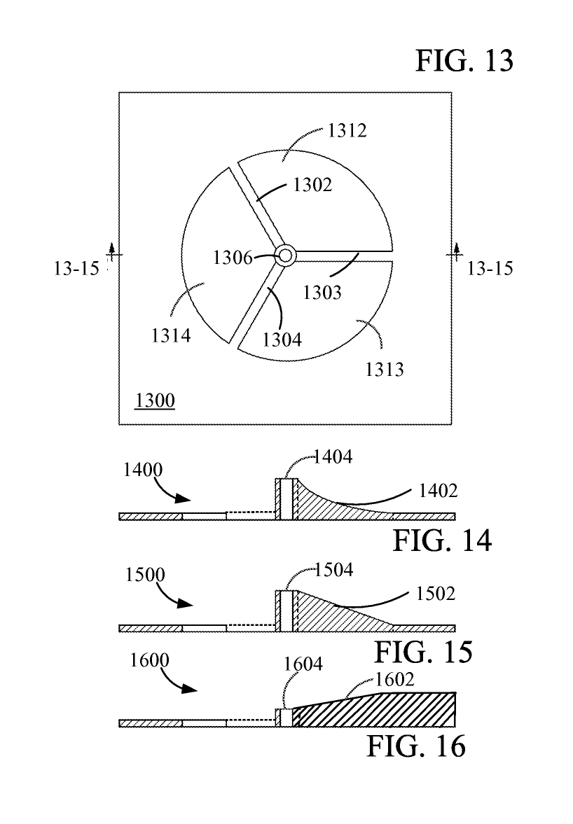

FIGS. 13-16 illustrate representative spider configurations. As shown in FIG. 13, a spider plate 1300 defines spider arms 1302-1304 that can be provided with planar or reflective curved surfaces and support a fiber retainer 1306. Sectional views of representative spider arms that can be used in a spider such as that of FIG. 13 are shown in FIGS. 14-16. In FIG. 14, a spider arm 1400 includes a curved reflective portion 1402 that is preferably tilted or decentered with respect to an axis of a fiber retaining aperture 1404. FIGS. 15-16 illustrate spider arms 1500, 1600 that include planar reflective portions 1502, 1602.

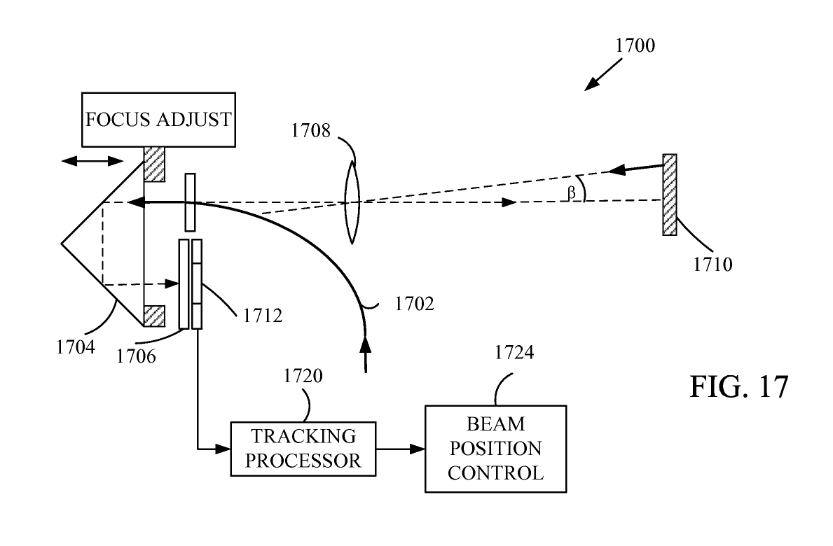

FIG. 17 illustrates a fiber coupled laser tracker or laser radar system 1700 in which an optical flux from a fiber 1702 is directed to a corner cube 1704 and a partially transmissive return reflector 1706 and then back through the corner cube 1704 to a lens 1708 that forms a focused interrogation beam that is directed to a target 1710. Portions of the interrogation beam that are returned to the lens 1708 are directed to the return reflector 1706 and portions transmitted by the return reflector 1706 are coupled to a detector 1712 such as a quadrant detector, a detector array, or other detectors so that beam location or pointing direction can be estimated. The optical flux from the fiber 1702 is also coupled to the detector 1712, and fiber location can also be estimated.

The detector 1702 is coupled to a tracking processor 1720 that determines beam position based on electrical signals associated with one or more and typically at least three photodetectors of the detector 1712. Based on the estimated beam position, a beam position controller 1724 can direct beam adjustment. Alternatively, an estimated beam position can be used in correcting position information in processing returned optical flux to establish object surface profiles, distances, or other object properties.

The reflector 1706 is typically configured to transmit less than about 10%, 5%, 1%, or 0.5% of an incident flux. In the configuration of FIG. 17, the return reflector 1706 is part of a focusing system, so that coupling flux to a detector for beam tracking does not otherwise disturb an optical system, except for a change in transmittance. However, in other examples, beam portions transmitted by fold mirrors can also be used for tracking In addition, in some cases, some beam portions escape the corner cube upon each reflection at rear surfaces, and these beam portions can also be directed to a detector for beam tracking

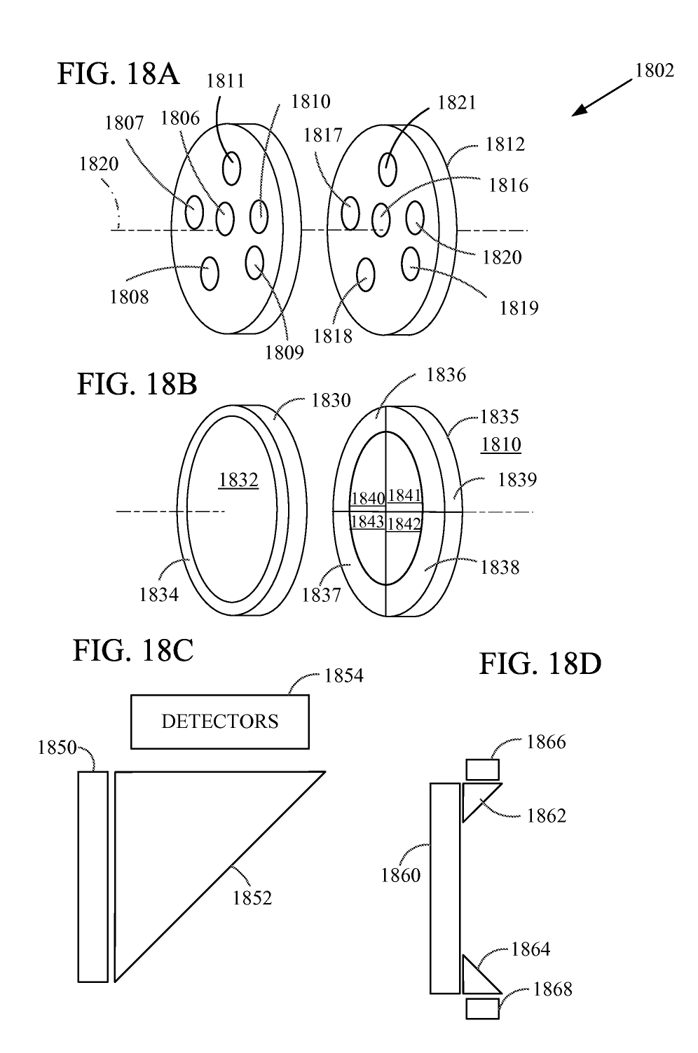

While a conventional multi-segmented detector or a quadrant detector can be situated so at to receive portions of a return beam transmitted by a return reflector as shown in FIG. 17, other detector configurations can be used as illustrated in FIGS. 18A-18D. With respect to FIG. 18A, a return reflector 1802 includes a reflective surface 1804 that is typically provided by a highly reflective multilayer dielectric coating. Selected areas 1806-1811 can be uncoated, or be provided with a less reflective coating so that portions of a return beam are transmitted to corresponding detectors (or detector segments) 1816-1821 that are secured to a detector plate 1812. As shown in FIG. 18A, the return reflector 1802 and the detector plate are situated on a common axis 1820, but none of the selected areas 1806-1811 need be situated on the common axis 1820.

In another example shown in FIG. 18B, a return reflector 1830 is provided with a reflective dielectric coating in a central area 1832 while an annular region 1834 remains transmissive. An annular detector 1835 that includes detector segments 1836-1839 is situated to receive transmitted beam portions from the annular region of the return reflector 1830. The detector segments 1836-1839 can be defined by portions of quadrant detector. In some examples, quadrant segments 1840-1843 are situated so as to receive transmitted beam portions from the central area 1832 of the return mirror 1830.

Referring to FIG. 18C, a return reflector 1850 is situated so as to transmit portions of a return beam to a prism 1852 that directs the portions to a detector assembly 1854. In another example shown in FIG. 18D, a return reflector 1860 is situated to couple transmitted beam portions to prisms 1862, 1864 that direct the received beam portions to respective detectors 1866, 1868. The prisms 1862, 1864 can be provided in a circular ring or as an axicon, if convenient.

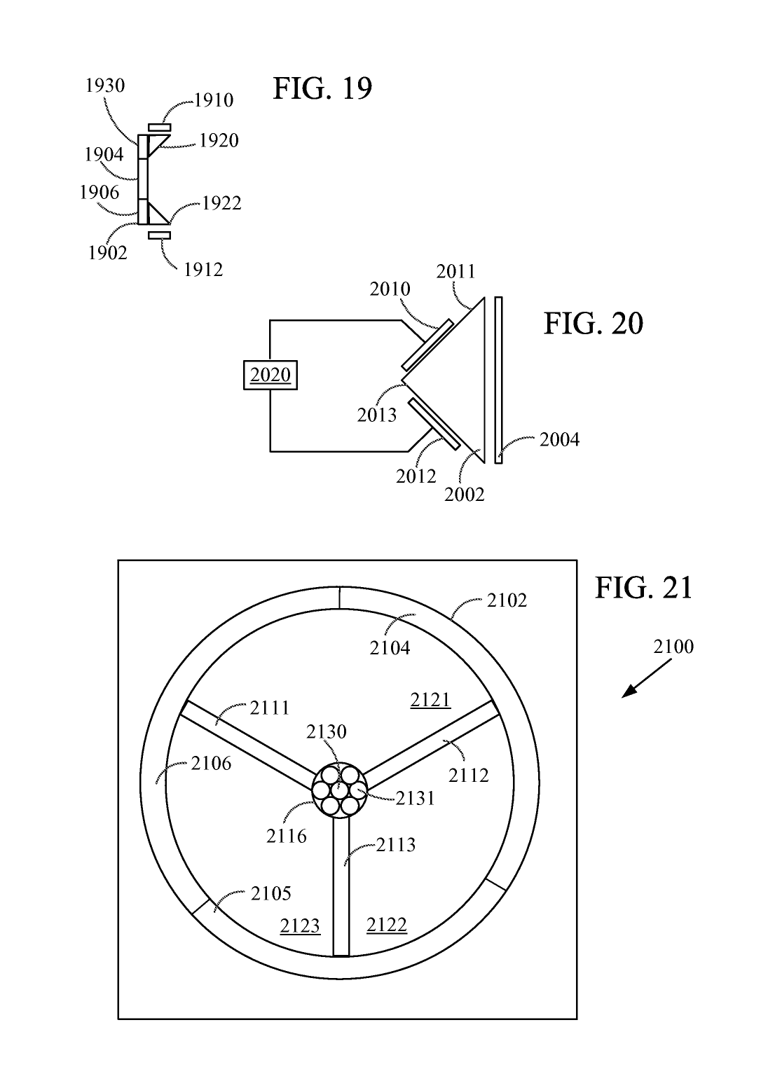

FIG. 19 illustrates a substrate 1902 that includes a return reflector 1904 defined by a reflective coating. A perimeter region 1906 of the substrate 1902 is transmissive so as to couple transmitted beam portions to one or more detectors such as representative detectors 1910, 1912. As shown in FIG. 19, prisms 1920, 1922 are situated to couple transmitted beam portions to the detectors 1910, 1912, but the detectors can be situated so as to face the transmitted beam portions to receive the transmitted beam portions without prisms. Alternatively, a front surface 1930 of the substrate 1902 at the perimeter region 1906 can be provided with prisms or reflectors situated to divert perimeter portion of an incident beam to one or more detectors.

FIG. 20 illustrates a prism 2002 and a return reflector 2004 situated to adjust a focus of an interrogation optical beam that is delivered to a target. Detectors 2010, 2012 are situated proximate selected surfaces 2011, 2013 of the prism 2002 and are coupled to a beam tracker 2020 that is configured to estimate an interrogation optical beam pointing direction.

FIG. 21 illustrates a spider mount 2100 that includes an annular detector 2102 that includes detector segments 2104-2106. Spider arms 2111-2113 are configured to support a fiber bundle retainer 2116, and the spider mount 2100 provides clear apertures 2121-2123 for optical beam transmission. As shown in FIG. 21, the fiber bundle retainer is configured to support a fiber bundle that includes a central fiber 2030 and a plurality of additional fibers such as representative fiber 2031. The central fiber 2030 is typically a single mode fiber configured to couple optical radiation to form an interrogation or tracking beam and receive return radiation from a target for laser radar or tracking operation. The additional fibers such as the fiber 2031 can be single mode or multimode fibers that are coupled to respective detectors or detector segments for detection of beam alignment or for use in object tracking.

The examples above can be combined with one another so that beam angle can be monitored at one or more locations. One or both of beam angles associated with an outgoing interrogation beam and/or a return beam from a target can be detected. Such detection can permit scan or pointing angle calibration either during operation or as part of a calibration procedure in which calibration values are stored. In other examples, a beam scan angle can be used in tracking an object.

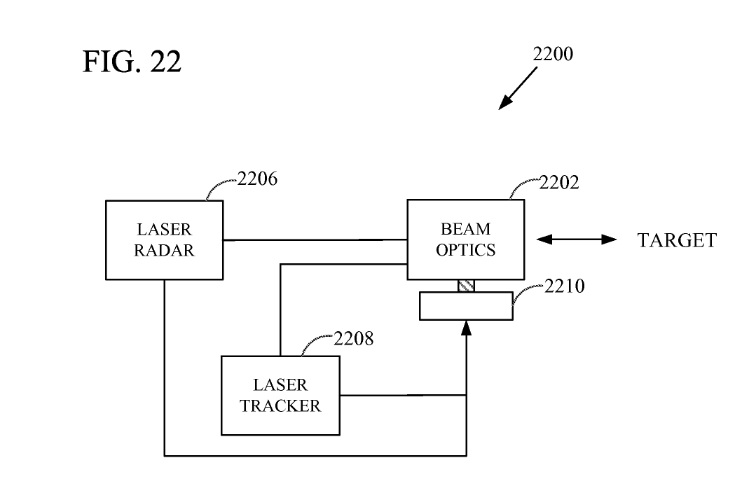

FIG. 22 is a block diagram of a combined laser radar/laser tracking system 2200. An optical system 2202 is configured to deliver an optical beam to a target and capture a received beam. A portion of the received beam (typically substantially all, for example, 50%, 75%,90% or more) is processed by a laser radar 2206 to determine target distance. A portion of the received beam is intercepted and processed by a laser tracker 2208 to estimate a target angle. The laser tracker 2208 (or the laser radar 2206) is coupled to an angular positioner 2210 so that the optical system 2202 can be oriented so as to direct a beam to the target. In some examples, a single optical beam is used for both tracking and laser radar, but separate beams can be used. The optical system 2202 is configured so that a beam interceptor situated to direct a beam portion to the laser tracker 2208 does not prevent delivery of appropriate beam portions to the laser radar 2206.

Different wavelengths can be used for the interrogation beam that is used to estimate distances to a target and a tracking beam that is used as, for example, a pointing beam. Either or both of an interrogation beam and tracking beam can be used to determine target locations. For example, a pointing beam can be used for target location, and an optical system configured to reduce or eliminate attenuation of the interrogation beam by tracking detectors/detector segments and optical components associated with the pointing beam.

In some disclosed examples, a common optical fiber and optical system are used for both transmission and reception of the interrogation beam. In other examples, separate optical fibers and/or optical systems can be provided for transmission and detection. Tracking detectors can be provided with either or both of transmission or detection optics.

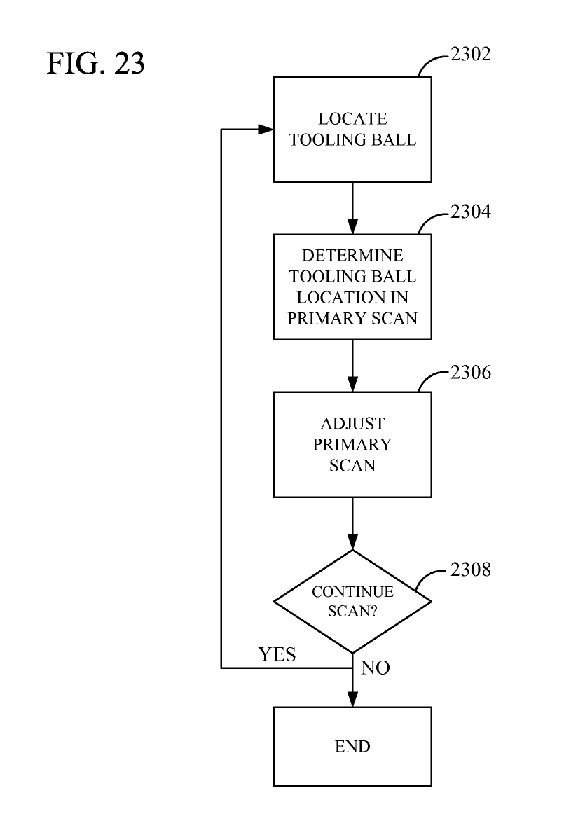

FIGS. 23-25 are schematic diagrams of representative methods that can incorporate the methods and apparatus described above.

FIG. 23 illustrates a representative method of tracking a tooling ball that is secured to a substrate or target. One or more tooling balls can be secured to a target to provide reference points for coordinate determinations. Tooling balls generally include a reflective ball-shaped surface in order to provide ample reflection of an interrogation beam in a laser-based measurement apparatus such as a laser radar.

As shown in FIG. 23 at 2302 a tooling ball location is identified and recorded based on returned portions of a scanned interrogation optical beam. The optical beam can be scanned in a variety of patterns such as circles, spirals, w′s, or zig-zags so as to track a tooling ball. At 2304, the identified location is evaluated to determine a position with respect to a primary scan. The primary scan is adjusted at 2306 so that the tooling ball location is at a preferred location with respect to the primary scan. Typically, the primary scan is adjusted so that the tooling location is approximately centered within a primary scan range. At 2308, a determination is made regarding additional scanning Scan adjustments can be made based on beam measurements such as described above.

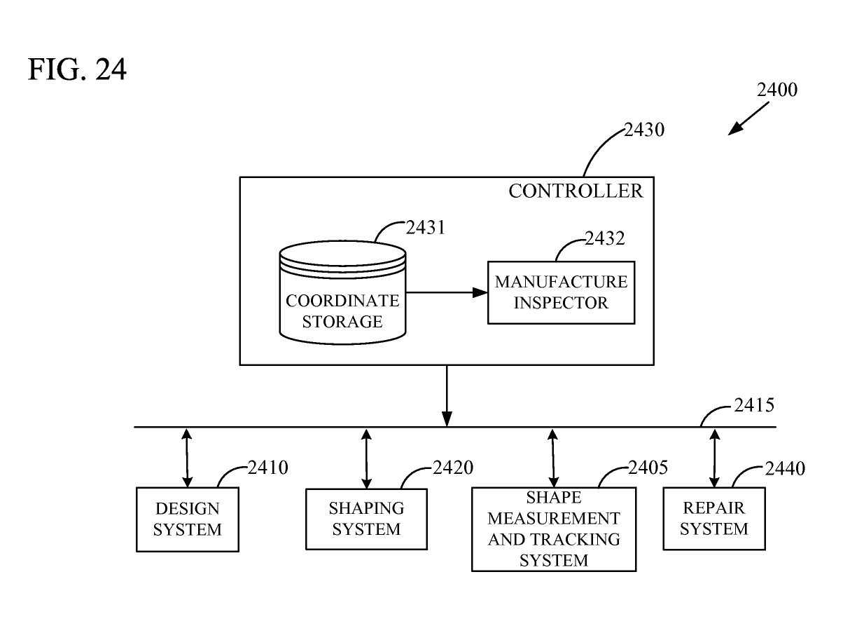

FIG. 24 illustrates a representative manufacturing system 2400 suitable for producing one or more components of a ship, airplane, or part of other systems or apparatus, and for evaluating and reprocessing such manufactured components. The system 2400 typically includes a shape or profile measurement system 2405 such as the laser radar 100 discussed above. The manufacturing system 2400 also includes a design system 2410, a shaping system 2420, a controller 2430, and a repair system 2440. The controller 2430 includes coordinate storage 2431 configured to store measured and design coordinates or other characteristics of one or more manufactured structures as designed and/or measured. The coordinate storage 2431 is generally a computer readable medium such as hard disk, random access memory, or other memory device. Typically, the design system 2410, the shaping system 2420, the shape measurement system 2405, and a repair system 2440 communicate via a communication bus 2415 using a network protocol.

The design system 2410 is configured to create design information corresponding to shape, coordinates, dimensions, or other features of a structure to be manufactured, and to communicate the created design information to the shaping system 2420. In addition, the design system 2410 can communicate design information to the coordinate storage 2431 of the controller 2430 for storage. Design information typically includes information indicating the coordinates of some or all features of a structure to be produced.

The shaping system 2420 is configured to produce a structure based on the design information provided by the design system 2410. The shaping processes provided by the shaping system 2420 can include casting, forging, cutting, or other process. The shape measurement and tracking system 2405 is configured to track an object or structure feature, measure the coordinates of one or more features of the manufactured structure and communicate the information indicating measured coordinates or other information related to structure shape to the controller 2430.

A manufacture inspector 2432 of the controller 2430 is configured to obtain design information from the coordinate storage 2431, and compare information such as coordinates or other shape information received from the profile measuring apparatus 100 with design information read out from the coordinate storage 2431. The manufacture inspector 2432 is generally provided as a processor and a series of computer-executable instructions that are stored in a tangible computer readable medium such as random access memory, a flash drive, a hard disk, or other physical devices. Based on the comparison of design and actual structure data, the manufacture inspector 2432 can determine whether or not the manufacture structure is shaped in accordance with the design information, generally based on one or more design tolerances that can also be stored in the coordinate storage 2431. In other words, the manufacture inspector 2432 can determine whether or not the manufactured structure is defective or nondefective. When the structure is not shaped in accordance with the design information (and is defective), then the manufacture inspector 2432 determines whether or not the structure is repairable. If repairable, then the manufacture inspector 2432 can identify defective portions of the manufactured structure, and provide suitable coordinates or other repair data. The manufacture inspector 2432 is configured to produce one or more repair instructions or repair data and forward repair instructions and repair data to the repair system 2440. Such repair data can include locations requiring repair, the extent of re-shaping required, or other repair data. The repair system 2440 is configured to process defective portions of the manufactured structure based on the repair data.

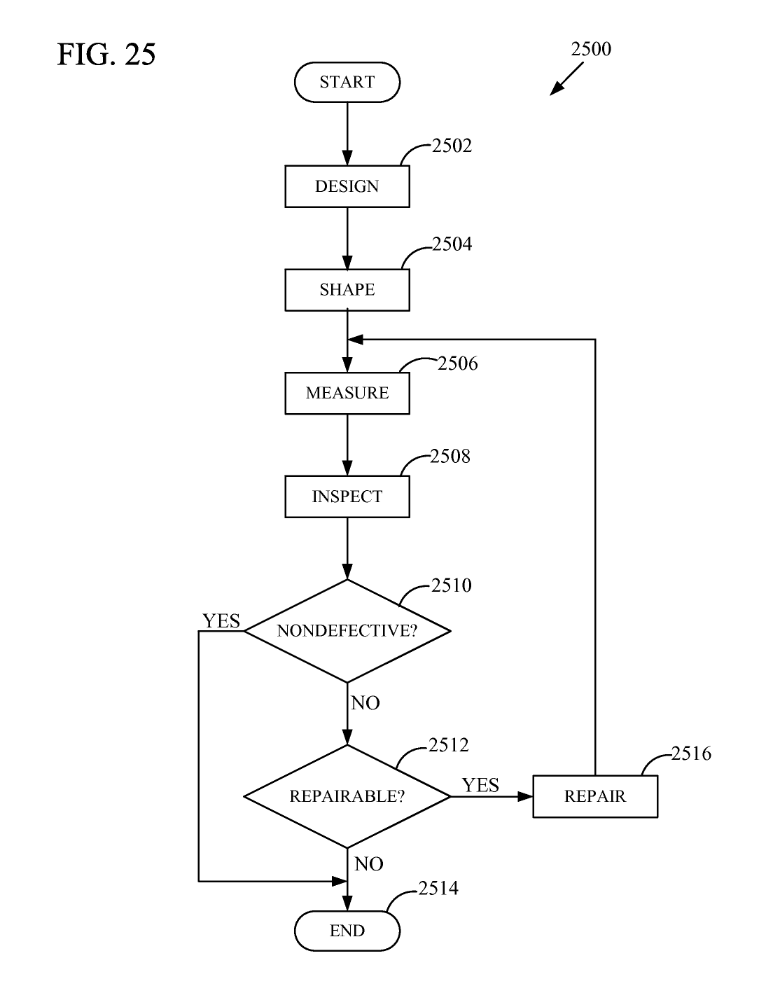

FIG. 25 is a flowchart showing a representative manufacture method 2500 that can incorporate manufacturing systems such as illustrated in FIG. 24. At 2502, design information is obtained or created corresponding to a shape of a structure to be manufactured. At 2504, the structure is manufactured or “shaped” based on the design information. At 2506, coordinates, dimensions, or other features of the manufactured structure are tracked and measured with a profile measurement system such as the laser systems described above to obtain shape information corresponding to the structure as manufactured. At 2508, the manufactured structure is inspected based on a comparison of actual and design dimensions, coordinates, manufacturing tolerance, or other structure parameters. At 2510, if the manufactured structure is determined to be nondefective, the manufactured part is accepted and processing ends at 2514. If the manufacture part is determined to be defective at 2510 by, for example, the manufacture inspector 2432 of the controller 2430 as shown in FIG. 24 then at 2512 it can be determined whether the manufacture part is repairable. If repairable, the manufactured part is reprocess or repaired at 2516, and then measured, inspected, and reevaluated at 2506, 2508, 2510, respectively. If the manufactured part is determined to be unrepairable at 2512, the process ends at 2514.

According to the method of FIG. 25, using a profile measurement system to accurately measure or assess coordinates or other features of a manufactured structure, a manufactured structure can be evaluated to determine if the structure is defective or nondefective. Further, if a manufactured structure is determined to be defective, a reprocessing process can be initiated if the part is deemed to be repairable based on design and actual structure dimensions and features. By repeating the measurement, inspection, and evaluation processes, defective parts can be reprocessed, and parts that are defective but that are not repairable can be discarded. The particular systems and methods of FIGS. 24-25 are exemplary only, and other arrangements can be used.

In the above embodiment, the structure manufacturing system 2400 can include a profile measuring system such as the system 100, the design system 2410, the shaping system 2420, the controller 2430 that is configured to determine whether or not a part is acceptable (inspection apparatus), and the repair system 2440. However, other systems and methods can be used and examples of FIGS. 24-25 are provided for convenient illustration.

In view of the many possible embodiments to which the principles of the disclosed technology may be applied, it should be recognized that the illustrated embodiments are only preferred examples and should not be taken as limiting in scope. We claim all that comes within the scope and spirit of the appended claims.

20

We claim:

1. A measurement apparatus, comprising:
a laser radar system configured to deliver an optical beam to a target, wherein a portion of the optical beam is reflected back to the laser radar system as an interrogation optical beam and an additional portion of the optical beam is reflected back to the apparatus as a tracking optical beam, wherein the laser radar system is configured to receive the interrogation optical beam with an objective lens situated along an axis, the objective lens configured to direct the received interrogation optical beam to a detection system so as to produce an estimate of a target distance; and
a tracking system configured to receive the tracking optical beam, the tracking system comprising a multi-element detector.

2. The measurement apparatus of claim 1, wherein the tracking system includes a processor configured to estimate an angular position of the target based on a distribution of the received portion or the tracking optical beam at the elements of the multi-element detector.

3. The measurement apparatus of claim 1, wherein the multi-element detector includes annular elements situated so as to define an aperture, wherein the interrogation beam passes through the aperture to the detection system.

4. The measurement apparatus of claim 1, wherein the multi-element detector is situated on the axis.

5. The measurement apparatus of claim 1, wherein the multi-element detector is situated proximate the objective lens.

6. The measurement apparatus of claim 1, wherein the measurement apparatus includes a focus adjustment system that includes a corner cube and a return reflector, wherein the return reflector is configured to transmit at least a portion of the tracking optical beam, and the multi-element detector is situated to receive the portion of the tracking beam transmitted by the return reflector.

7. The measurement apparatus of claim 6, wherein the multi-element detector is a quadrant detector.

8. The measurement apparatus of claim 6, wherein the multi-element detector is a detector array.

9. The measurement apparatus of claim 6, wherein the return reflector includes a patterned partially transmissive coating configured to transmit portions of the tracking beam at at least one pattern area to the multi-element detector and reflect other portions back to the corner cube.

10. The measurement apparatus of claim 6, further comprising at least one reflective surface configured to direct the portion of the tracking beam transmitted by the return reflector to the multi-element detector.

11. The measurement apparatus of claim 1, wherein the laser radar includes a focus adjustment system that includes a corner cube and a return reflector, wherein the multi-element detector is situated proximate to the return reflector.

12. The measurement apparatus of claim 11, wherein the multi-element detector is situated as to receive at least a portion of the tracking beam as either directed toward the return reflector or, reflected by the return reflector.

13. The measurement apparatus of claim 1, wherein the optical beam, the interrogation beam, and the tracking beam all pass through the objective lens.

14. The measurement apparatus of claim 13, further comprising a focus controller configured to selectively adjust a beam focus so as to produce the interrogation optical beam and the tracking optical beam.

15. The measurement apparatus of claim 14, wherein the focus controller is configured to produce an interrogation optical beam which is substantially focused at the target, and to further produce a collimated tracking optical beam.

16. The measurement apparatus of claim 15, further comprising at least one laser diode configured to produce the interrogation optical beam and the tracking optical beam.

17. The measurement apparatus of claim 1, further comprising a beam pointing system configured to select a beam pointing direction based on the received portion of the tracking optical beam.

18. The measurement apparatus of claim 2, further comprising a beam pointing system configured to select a beam pointing direction based on the estimated angular position.

19. The measurement apparatus of claim 18, wherein the beam pointing system is configured to direct the optical beam to the estimated angular position.

20. The measurement apparatus of claim 1, further comprising an optical fiber situated so as to direct the optical beam to the objective lens and a spider mount having at least two spider legs configured to retain the optical fiber, and wherein at least two elements of the multi-element detector are situated to receive the portion of the tracking optical beam which is obstructed by respective spider legs.

21. The measurement apparatus of claim 20, wherein the at least two elements of the multi-element detector are secured to the respective spider legs.

22. The measurement apparatus of claim 20, wherein the spider legs include reflective surfaces situated to direct the tracking optical beam portion to the at least two detector elements.

23. The measurement apparatus of claim 22, wherein at least one of the reflective surfaces is configured to direct the tracking beam portion away from the axis.

24. The measurement apparatus of claim 22, wherein at least one of the reflective surfaces is configured to focus the tracking beam portion at a selected element of the multi-element detector.

25. The measurement apparatus of claim 24, wherein the multi-element detector includes annular elements that define a central aperture situated to transmit the interrogation optical beam.

26. A method, comprising:
directing an optical beam to a target;
receiving at least a portion of the optical beam reflected from the target along a laser radar axis;
directing a portion of the received optical beam to a multi-element detector; and
based on portions of the received optical beam detected by the elements of the multi-element detector, estimating an angular location of the target.

27. The method of claim 26, further comprising adjusting the laser radar axis based on the estimated angular location.

28. The method of claim 26, wherein the elements of the multi-element detector are situated to receive perimeter portions of the received optical beam.

29. The method of claim 26, wherein the received optical beam is directed to an optical fiber associated with the laser radar, and the elements of the multi-element detector are situated to receive portions of the received optical beam obstructed by a fiber mount.

30. The method of claim 29, wherein the fiber mount is a spider mount having a plurality of spider arms, and the elements of the multi-element detector are situated to receive portions of the received optical beam obstructed by the spider arms.

31. The method of claim 30, wherein the spider arms are configured to reflect portions of the received optical beam to the elements of the multi-element detector.

32. The method of claim 26, wherein the laser radar includes a focus adjustment system, and the elements of the multi-element detector are situated to receive portions of the received optical beam from the focus adjustment system.

33. The method of claim 32, wherein the focus adjustment system includes a corner cube configured to be translatable along a local optical axis and a return reflector, and further wherein the return reflector couples the received optical beam to the multi-element detector.

34. The method of claim 33, wherein the return reflector couples the received optical beam to the multi-element detector by transmission.

35. The method of claim 33, wherein the return reflector couples the received optical beam to the multi-element detector by reflection.

36. The method of claim 26, further comprising:
estimating a target distance by directing an interrogation optical beam to the target along the laser radar axis; and
directing a tracking optical beam to the target such that the received optical beam corresponds to a portion of the tracking optical beam, wherein the estimated angular location of the target is determined with respect to the laser radar axis.

37. The method of claim 36, wherein the interrogation optical beam is focused at the target, and the tracking optical beam is a collimated optical beam.

38. The method claim 26, further comprising repetitively adjusting an orientation of the laser radar axis based on the estimated angular location.

39. The method of claim 26, further comprising estimating the angular location of the target based on signals associated with a received power difference between at least two elements of the multi-element detector.

40. The method of claim 26, wherein the elements of the multi-element detector are annular elements situated so as to define an aperture, wherein the aperture is configured to transmit a central portion of the received optical beam to a laser radar detection system.

41. A laser radar and tracker, comprising:
an optical system configured to direct an optical beam along a laser radar axis to a target and receive a return beam so as to determine a target distance; and
means for intercepting a portion of the return optical beam;
a processor configured determine a target angular location based on the intercepted portion of the return beam.

42. The apparatus of claim 41, wherein the optical system includes focusing optics that direct the optical beam to the target, wherein the means for intercepting is a segmented annular photodetector having a central transmissive portion that is situated on the laser radar axis.

43. The apparatus of claim 41, wherein the optical system includes at least one partially transmissive mirror, and the means for intercepting includes at least two photodetectors situated to receive a portion of the optical beam transmitted by the partially transmissive mirror.

44. The apparatus of claim 41, wherein:
the optical system includes a spider mount configured to retain a fiber end that delivers an optical flux to form the optical beam, the spider mount including a plurality of spider arms extending radially outwardly from a fiber retainer; and
the means for intercepting are the spider arms.

45. The apparatus of claim 41, wherein the portion of the interrogation beam received by the beam tracking system is a peripheral beam portion with respect to the axis.

46. An optical apparatus, comprising:
an optical system configured to produce an interrogation optical beam, the optical system including a spider mount having a plurality of spider arms, and configured to secure an optical fiber along an axis and direct an optical flux from the fiber to a focusing element to produce the interrogation optical beam; and
a beam tracker configured to produce a beam position estimate based on portions of the optical flux returned from a target and incident to the spider arms.

47. The apparatus of claim 46, further comprising photodetectors situated at one or more of the spider arms, wherein the beam tracker is configured to produce the beam position estimate based on electrical signals associated with the portion of the optical flux returned from the target incident to the photodetectors.

48. The apparatus of claim 46, further comprising reflective surfaces at one or more of the spider arms and situated to direct portions of the returned optical flux to one or more detectors, wherein the beam tracker is configured to produce the beam position estimate based on electrical signals associated with the portion of the returned optical flux incident to the photodetectors.

49. An optical apparatus, comprising:
an optical system configured to produce an interrogation optical beam, the optical system including a beam focusing element and a partially transmitting return reflector situated on an axis, the return reflector situated so that a separation of the beam focusing element and the return reflector is variable so as to focus the interrogation optical beam at a target; and
a beam position detection system configured to receive at least a portion of a return optical flux from the target either transmitted or reflected by the return reflector.
